(19) United States
(12) Patent Application Publication
(10) Pub. No.: US 2013/0255501 A1
(43) Pub. Date: Oct. 3, 2013

(54) Oil Mist Filter

(71) Applicant: Wei Sun, Taichung City (TW)

(72) Inventor: Wei Sun, Taichung City (TW)

(21) Appl. No.: 13/853,640

(22) Filed: Mar. 29, 2013

(30) Foreign Application Priority Data
Apr. 3, 2012 (TW) 101206052

(51) Int. Cl. B01D 45/06

(52) U.S. Cl. CPC B01D 45/06
USPC 96/135; 55/332

(57) ABSTRACT

An oil mist filter is provided with a housing, a shell, a filtering assembly and a sucking mechanism which are disposed in the housing and the cover, and a filtering cylinder mounted outside the shell. The arrangement of the filtering space, the sucking space and the oil-collecting chamber inside the housing, and the interior of the shell being in communication of the filtering cylinder, changes the flow direction of the oil mist, so that the oil mist is guided to and discharged out of the filtering cylinder.

### BACKGROUND OF THE INVENTION

1. Field of the Invention

The present invention relates to a filter, and more particularly to an oil mist filter capable of effectively filtering and collecting oil mist.

2. Description of the Prior Art

As shown in FIG. 1, a conventional oil mist filter 10 is used to collect the oil mist produced by the evaporation of cutting oil which is used by a cutting machine to perform cutting operation, and high cutting temperature causes evaporation of the cutting oil. The oil mist filter 10 comprises a housing 11 which serves to suck oil mist and perform preliminary filtering, and a filtering cylinder 12 to perform final filtering.

The housing 11 is provided with a first filtering space 111, a sucking space 112 and a second filtering space 113. Between the first and second filtering spaces 111, 113 are arranged an inlet 114 and an outlet 115. A sucking mechanism 13 is disposed in the sucking space 112 to suck oil mist. In the first filtering space 111 is disposed a first filtering member 14 located at a position where the first filtering space 111 is in communication with the sucking space 112, and in the second filtering space 113 is disposed a second filtering member 15 located at a position where the second filtering space 113 is in communication with the outlet 115. The filtering cylinder 12 includes a pipe 121 in communication with the outlet 115. By such arrangements, oil mist is drawn from the inlet 114 by the sucking mechanism 13 into the first filtering space 111 and filtered by the first filtering member 14, then the oil mist filtered by first filtering member 14 is further drawn into the second filtering space 113 and filtered by the second filtering member 15, and finally the oil mist flows through the pipe 121 and is discharged out after finally being filtered by the filtering cylinder 12.

It seems that the filtering effect will be good since the oil mist filter 10 comprises three filtering processes, but it's not true due to the following factors:

First, the first filtering member 14 is provided with a slanting screen 141 located toward the inlet 114, and the slanting direction of the screen 141 will guide the oil mist to flow downward, so that the first filtering member 14 cannot be effectively used, and only the oil mist in the lower side of the space can be filtered, resulting in low filtering efficiency and increase of filtering cost.

Second, as shown in FIG. 1, oil mist will flow through the second filtering member 15 before being finally filtered by the filtering cylinder 12, however, the second filtering member 15 is located at the lowest position in the conventional oil mist filter 10. Therefore, when the dirty oil in the sucking space 112 and the pipe 121 of the filtering cylinder 12 accumulates to a certain extent, it will move toward the second filtering member 15 because of gravity, causing clogging of the second filtering member 15.

Third, the second filtering member 15 will be clogged if it is not timely replaced, and the oil mist won't be able to flow into the next filtering cylinder 12, leading to low filtering efficiency.

The present invention has arisen to mitigate and/or obviate the afore-described disadvantages.

### SUMMARY OF THE INVENTION

The primary objective of the present invention is to provide an oil mist filter which effectively improves the oil filtering effect by changing the oil mist flow direction with the arrangement of the inner filtering space.

To achieve the above objective, an oil mist filter in accordance with the present invention comprises: a housing, a shell, a filtering assembly and a sucking mechanism which are disposed in the housing and the cover, and a filtering cylinder mounted outside the shell. The housing has a base and a top cover on the base, the base is formed with an oil-collecting chamber, and the top cover is formed with a filtering space and a sucking space. The housing defines an axis extending through the filtering space and the sucking space, the filtering space is formed with an intake port in communication with outside, and an opposite sucking port in communication with the sucking space. The sucking space is formed with an assembling hole located corresponding to the sucking hole, and an exhaust port is formed at a bottom of the sucking space and in communication with the oil-collecting chamber of the base. The housing is further provided with an oil-discharging hole at a bottom of the filtering space and at a bottom of the oil-collecting chamber, respectively. The shell is a hollow structure provided with an inlet and outlet which are located at top and bottom of the shell, respectively, and in communication with the oil-collecting chamber of the housing. The shell is further provided along the axis with a receiving port which is located corresponding to the assembling hole of the housing. The filtering assembly provided with a porous spoiler curved in an arc convex toward the intake port of the top cover, and a first filtering screen and a second filtering screen are arranged between the spoiler and the sucking port of the top cover. The sucking mechanism is provided with a wind wheel disposed in the sucking space of the housing, and a motor disposed in the receiving port of the shell, the wind wheel is connected to and rotated by the motor. The filtering cylinder is a hollow structure provided on an inner surface thereof with an inner filtering layer and an outer filtering layer, and the filtering cylinder has a closed end and an opposite open end which is in communication with the outlet of the shell, by such arrangements, oil mist is sucked into the intake port of the housing and filtered by the filtering assembly, then flows through the sucking space, the oil-collecting chamber and the shell, and then is filtered by the inner and outer filtering layers and finally exhausted from the filtering cylinder.

### BRIEF DESCRIPTION OF THE DRAWINGS

FIG. 1 is a cross sectional view of a conventional oil mist filter;

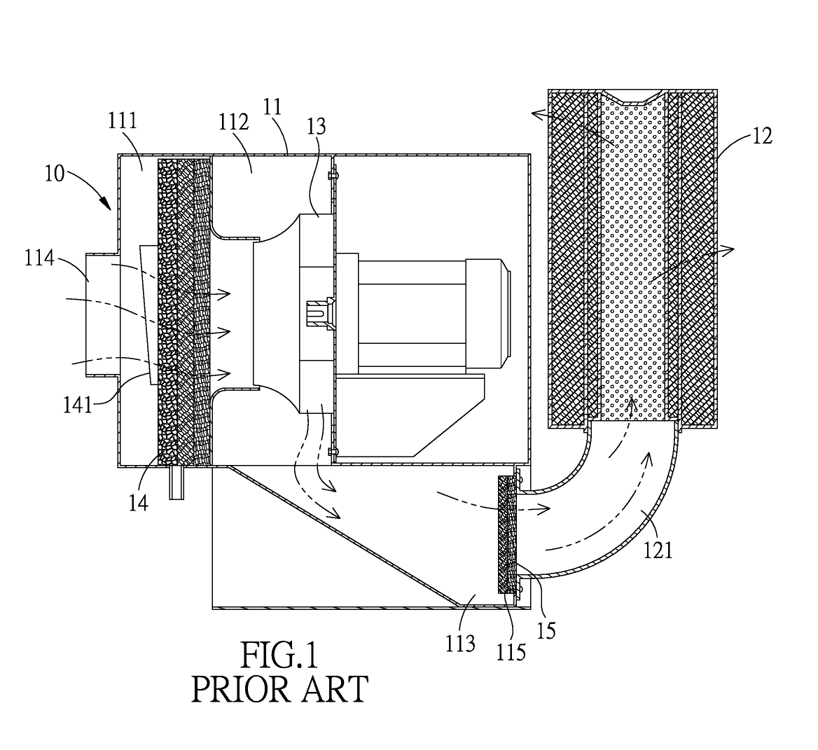

FIG. 2 is an exploded view of an oil mist filter in accordance with the present invention;

FIG. 3 is an assembly view of the oil mist filter in accordance with the present invention; and

FIG. 4 is a cross sectional view of the oil mist filter in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

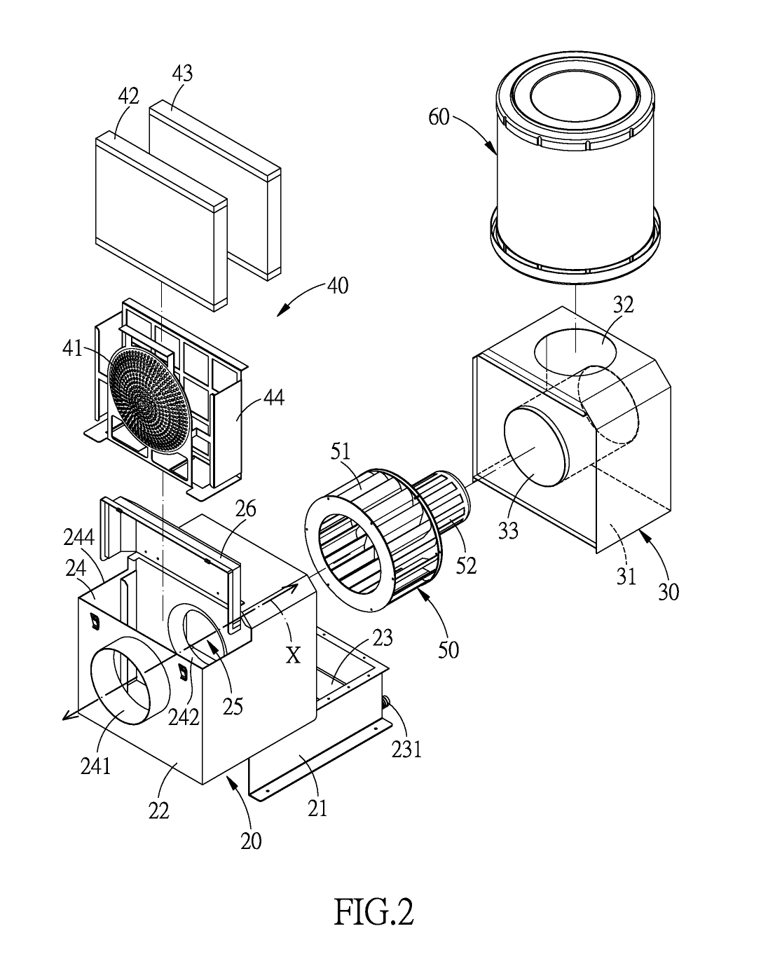

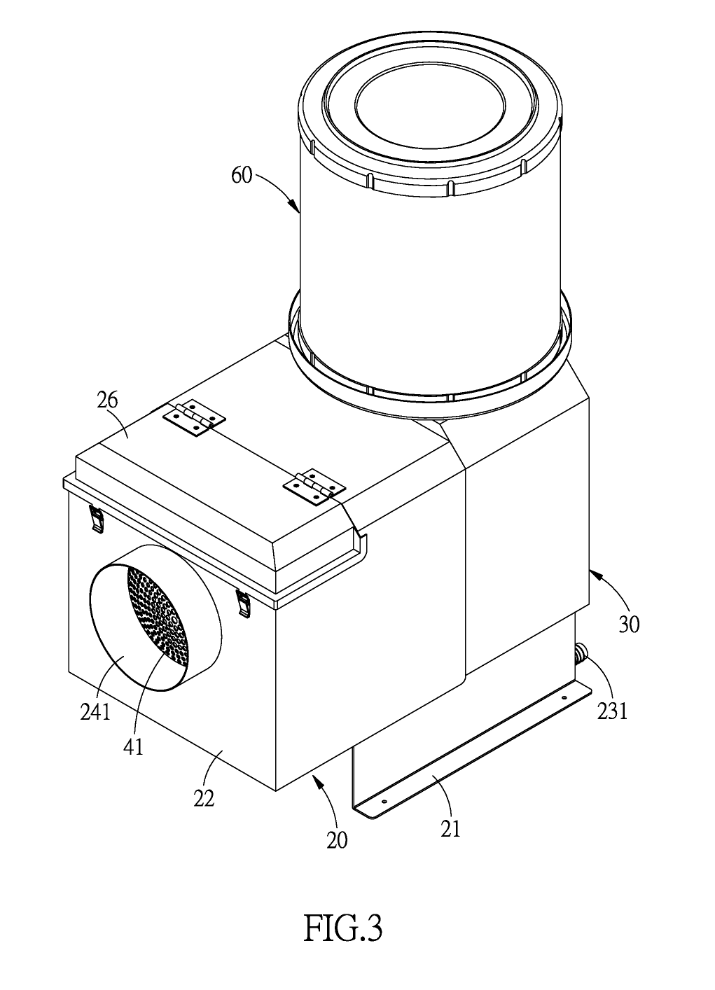

Referring to FIGS. 2-4, an oil mist filter in accordance with a preferred embodiment of the present invention comprises: a housing 20, a shell 30, a filtering assembly 40 and a sucking mechanism 50 which are disposed in the housing 20 and the shell 30, and a filtering cylinder 60 mounted outside the shell 30.

The housing 20 includes a base 21 and a top cover 22 on the base 21 which are arranged in a staggered manner. The base 21 is formed with an oil-collecting chamber 23. The top cover 22 is formed with a filtering space 24 and a sucking space 25. The housing 20 defines an axis X extending through the filtering space 24 and the sucking space 25. The filtering space 24 is formed with an intake port 241 in communication with outside, and an opposite sucking port 242 in communication with the sucking space 25. The sucking space 25 is formed with an assembling hole 251 located corresponding to the sucking hole 242, and an exhaust port 252 is formed at a bottom of the sucking space 25 and in communication with the oil-collecting chamber 23 of the base 21.

As shown in FIG. 2, an inserting hole 244 is formed at the top of the filtering space 24 of the top cover 22 for insertion of the filtering assembly 40 and covered with a cover 26.

The shell 30 is a hollow structure provided with an inlet 31 and outlet 32 which are located at the top and bottom of the shell 30, respectively, and in communication with the oil-collecting chamber 23 of the housing 20. The shell 30 is further provided along the axis X with a receiving port 33 which is located corresponding to the assembling hole 251 of the housing 20.

The filtering assembly 40 is provided with a porous spoiler 41 curved in an arc convex toward the intake port 241 of the top cover 22, and a first filtering screen 42 and a second filtering screen 43 are arranged between the spoiler 41 and the sucking port 242 of the top cover 22. In this embodiment, the filtering assembly 40 further comprises a mounting rack 44 for insertion of the first and second filtering screens 42, 43, and the spoiler 41 is also mounted on the mounting rack 44 and located toward the intake port 241 of the top cover 22. The first filtering screen 42 is a twill weave screen made of stainless steel, and the second filtering screen 43 is made of cotton fiber.

The sucking mechanism 50 comprises a wind wheel 51 disposed in the sucking space 25 of the housing 20, and a motor 52 disposed in the receiving port 33 of the shell 30. The wind wheel 51 is connected to and rotated by the motor 52. In this embodiment, the wind wheel 51 is axially provided along the axis X with an inserting hole 511 for insertion of the rotation shaft 521 of the motor 52, and the rotation shaft 521 rotates the wind wheel 51.

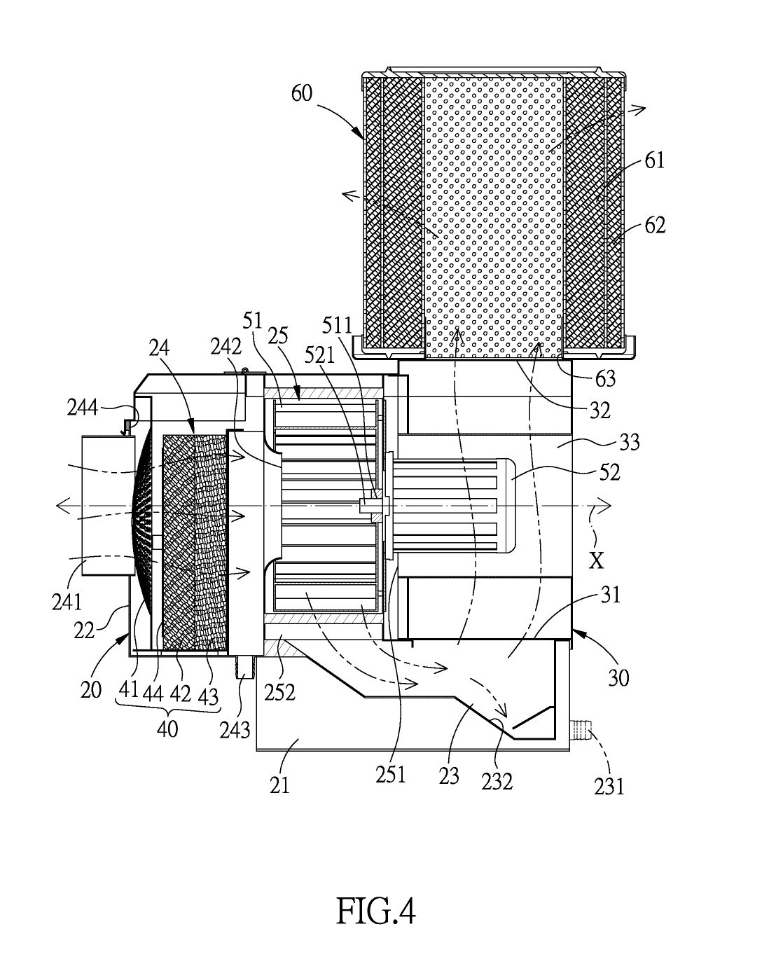

The filtering cylinder 60, as shown in FIG. 4, is a hollow structure provided on an inner surface thereof with an inner filtering layer 61 and an outer filtering layer 62. The filtering cylinder 60 has a closed end and an opposite open end 63 which is in communication with the outlet 32 of the shell 30. In this embodiment, the inner filtering layer 61 of the filtering cylinder 60 is made of cotton fiber, and the outer filtering layer 62 is made of activated carbon.

By such arrangements, oil mist is sucked into the intake port 241 of the housing 20 and filtered by the filtering assembly 40, then flows through the sucking space 25, the oil-collecting chamber 23 and the shell 30, and is then filtered by the inner and outer filtering layers 61, 62 and finally exhausted from the filtering cylinder 60.

Referring then to FIG. 4, the rotation of the wind wheel 51 produces a suction force to suck oil mist into the intake port 241, and then the oil mist is filtered by the filtering assembly 40 and the filtering cylinder 60 into clean air and finally discharged to the atmosphere. As shown in FIGS. 2 and 4, the housing 20 is further provided with an oil-discharging hole 243, 231 at the bottom of the filtering space 24 and the bottom of the oil-collecting chamber 23, respectively, so that the oil accumulated in the filtering space 24 after the oil mist was filtered by the filtering assembly 40 can be discharged via the oil-discharging hole 243, and the oil accumulated on the inner surface of the sucking spacer 25 and the shell 30 will be guided by an inclined bottom surface 232 of the oil-collecting chamber 23 to the oil-discharging hole 231 and finally discharged via the oil-discharging hole 231.

With the arc convex-shaped spoiler 41, oil mist can be evenly guided to pass through the filtering screens 42, 43 of the filtering assembly 40, enhancing the filtering effect. Furthermore, arranging the filtering cylinder 60 above the shell 30 changes the flow direction of the oil mist, which not only avoids the oil clogging and low filtering efficiency of the conventional oil mist filter, but also simplifies the structure of the oil mist filter.

While we have shown and described various embodiments in accordance with the present invention, it is clear to those skilled in the art that further embodiments may be made without departing from the scope of the present invention.

What is claimed is:

1. An oil mist filter, comprising:
a housing with a base and a top cover on the base, the base being formed with an oil-collecting chamber, the top cover being formed with a filtering space and a sucking space, the housing defining an axis extending through the filtering space and the sucking space, the filtering space being formed with an intake port in communication with outside, and an opposite sucking port in communication with the sucking space, the sucking space being formed with an assembling hole located corresponding to the sucking hole, and an exhaust port being formed at a bottom of the sucking space and in communication with the oil-collecting chamber of the base, the housing being further provided with an oil-discharging hole at a bottom of the filtering space and at a bottom of the oil-collecting chamber, respectively;
a shell being a hollow structure provided with an inlet and outlet which are located at top and bottom of the shell, respectively, and in communication with the oil-collecting chamber of the housing, the shell being further provided along the axis with a receiving port which is located corresponding to the assembling hole of the housing;
a filtering assembly provided with a porous spoiler curved in an arc convex toward the intake port of the top cover, and a first filtering screen and a second filtering screen being arranged between the spoiler and the sucking port of the top cover;
a sucking mechanism provided with a wind wheel disposed in the sucking space of the housing, and a motor disposed in the receiving port of the shell, the wind wheel being connected to and rotated by the motor; and
a filtering cylinder being a hollow structure provided on an inner surface thereof with an inner filtering layer and an outer filtering layer, and the filtering cylinder having a closed end and an opposite open end which is in communication with the outlet of the shell, by such arrangements, oil mist is sucked into the intake port of the housing and filtered by the filtering assembly, then flows through the sucking space, the oil-collecting chamber and the shell, and then is filtered by the inner and outer filtering layers and finally exhausted from the filtering cylinder.

2. The oil mist filter as claimed in claim 1, wherein an inserting hole is formed at the top of the filtering space of the top cover for insertion of the filtering assembly and covered with a cover.

3. The oil mist filter as claimed in claim 1, wherein the first and second filtering screens are inserted in a mounting rack, and the spoiler is mounted on the mounting rack and located toward the intake port of the top cover.

4. The oil mist filter as claimed in claim 1, wherein the first filtering screen is a twill weave screen made of stainless steel, and the second filtering screen is made of cotton fiber.

5. The oil mist filter as claimed in claim 1, wherein the inner filtering layer of the filtering cylinder is made of cotton fiber, and the outer filtering layer is made of activated carbon.
